(19) United States
(12) Patent Application Publication
(10) Pub. No.: US 2005/0099008 A1
(43) Pub. Date: May 12, 2005

(54) Adapter ring for fluid connectors

(76) Inventor: Donald S. Glover, Birmingham, MI (US)

Correspondence Address: Edgar A. Zarins;Masco Corporation, 21001 Van Born Road, Taylor, MI, 48180, US

(21) Appl. No.: 10/840,999

(22) Filed: May 7, 2004

Related U.S. Application Data
(60) Provisional application No. 60/519,246, filed on Nov. 12, 2003.

(51) Int. Cl. F16L 13/02

(52) U.S. Cl. 285/357

(57) ABSTRACT

An adapter ring for connecting male and female thread members of different diameters without substantially increasing the size of the connection. The adapter ring includes external threads for connecting to a female nut and internal threads for receiving a male member. The internal and external threads are concentrically and harmonically aligned to minimize the size of the adapter. In addition, the major diameter of the internal threads is greater than the minor diameter of the external threads.

### RELATED APPLICATIONS

This application claims priority from U.S. Provisional Application No. 60/519,246 filed on Nov. 12, 2003.

### BACKGROUND OF THE INVENTION

I. Field of the Invention

This invention relates to fluid connectors for plumbing apparatus and, in particular, to a low profile adapter ring which facilitates the connection of plumbing fittings of different sizes.

II. Description of the Prior Art

While it is preferred that connections between fluid conducting devices is universal to allow the use of any manufacturers products, many manufacturers have developed individual standards. Consumers would prefer that any fluid connector they purchase can be immediately connected to the plumbing device. However, manufacturers have adopted differing connection standards. Furthermore, it would be advantageous for a manufacturer of flexible connectors to stock a limited variety of connectors which could be used in connection with different plumbing devices.

For instance, in order to install a flexible connector between a 1/2 inch faucet shank and the 15/16 inch male member of a toilet fill valve, either a specialized connector or an adapter fitting must be used. The stocking of specialized connectors can be cost prohibitive. The prior known adapters include longitudinally separated threads which add to the length of the connection and create an unsightly arrangement. Such adapters typically include a tubular body with outer threads at one end and inner threads at the other end thereby creating an elongated device.

### SUMMARY OF THE PRESENT INVENTION

The present invention overcomes the disadvantages of the prior known connections by providing an adapter which can accommodate connections of different sizes without a substantial increase in length.

The adapter of the present invention includes a substantially tubular body having a throughbore. The body is formed with identical nested threads on the inner and outer surfaces of the body creating a male-female adapter. By way of example, the outer threads are formed at 14 threads per inch and the inner threads are formed at 14 threads per inch. However, in order to facilitate a minimal reduction, such as from a 15/16 inch connector, the threads on the inner and outer surface are formed in synchronous alignment. The troughs of the inner threads align with the crests of the outer threads, and vice-versa. Furthermore, in order to accommodate the required reduction in the connection, the major diameter of the internal thread is greater than the minor diameter of the external thread. This results in an adapter of minimum length and minimum wall thickness to accommodate a variety of connections.

Other objects, features and advantages of the invention will be apparent from the following detailed description taken in connection with the accompanying drawings.

### BRIEF DESCRIPTION OF THE DRAWING

The present invention will be more fully understood by reference to the following detailed description of a preferred embodiment of the present invention when read in conjunction with the accompanying drawing, in which like reference characters refer to like parts throughout the views and in which:

FIG. 1 is an exploded view of a fluid connection incorporating the adapter ring embodying the present invention;

FIG. 2 is a cross-sectional view of the fluid connection;

FIG. 3 is an end view of the adapter ring; and

FIG. 4 is a cross-sectional view of the adapter ring.

### DETAILED DESCRIPTION OF A PREFERRED EMBODIMENT OF THE PRESENT INVENTION

Referring first to FIG. 1, there is shown an exploded perspective of a conventional plumbing connection including a flexible fluid connector 10 adapted for connection to a male threaded member 12 such as a male connection on a toilet fill valve. In this example, the fluid connector 10 includes a flexible hose 14 and a female nut 16 having internal threads 18 of predetermined size. The male member 12 is of a smaller dimension but includes external threads 19. Although it would be preferred that the female nut 16 exactly matches the male member 12, in the field, such is not always the case. In order to transition between the different sized connections, the present invention provides a compact adapter ring 20.

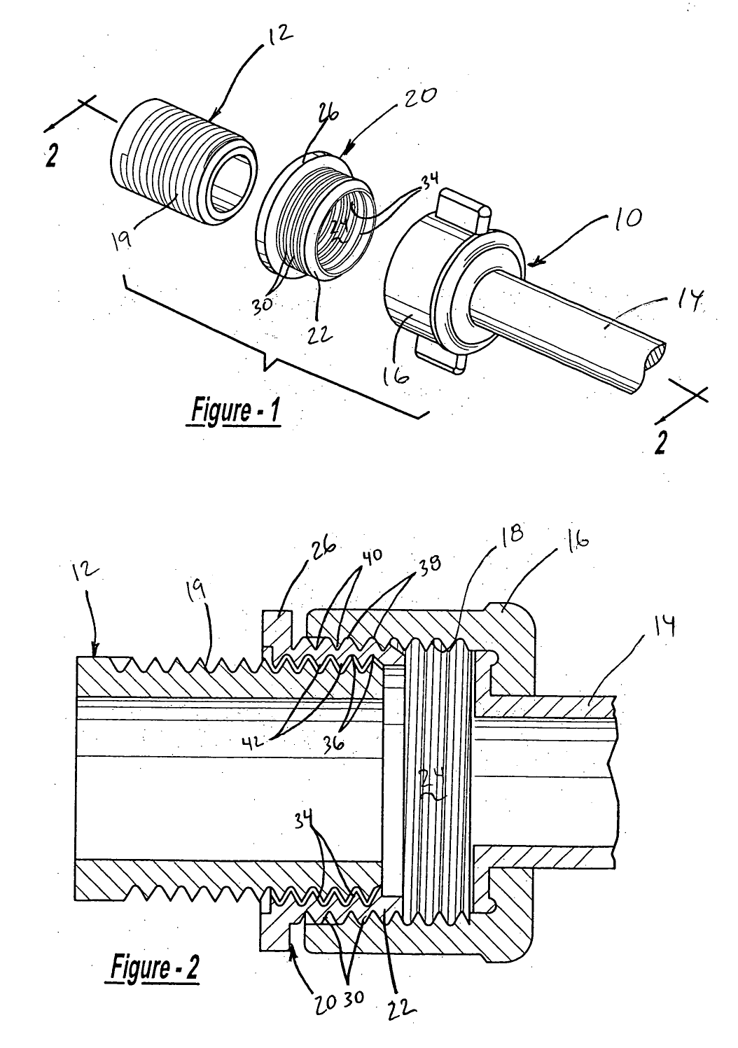

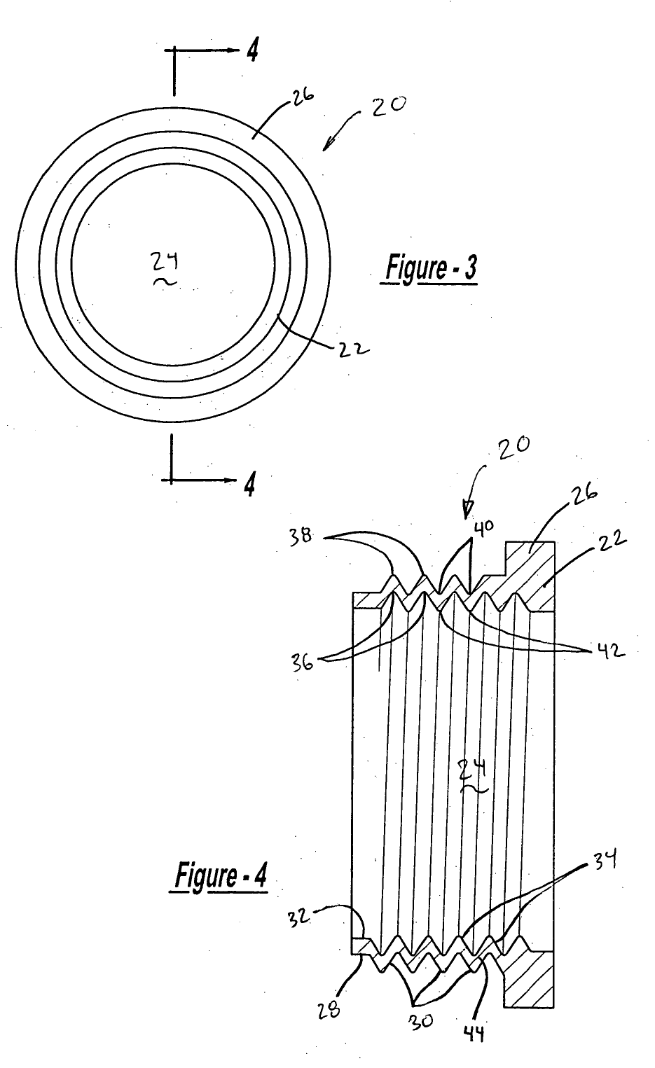

Referring now to FIGS. 1 through 4, the adapter ring 20 has a substantially tubular body 22 forming a fluid passageway 24. In order to facilitate manipulation of the adapter 20, the body 22 includes a radial flange 26 at one end thereof. An outer surface 28 of the body 22 includes external threads 30 an inner surface 32 of the body 22 includes internal threads 34. In the preferred embodiment of the present invention, the threads 30,34 are coaxially disposed on the body 22 and of equal thread count and size. For example, both the threads 30,34 could be formed at 14 threads per inch.

As is best shown in FIG. 4, in order to minimize the size of the adapter ring 20, the threads 30,34 are harmonically aligned such that the trough 36 of the internal threads 34 aligns with the crest 38 of the external threads 30. Accordingly, the trough 40 of the external threads 30 will align with the crest 42 of the internal threads 34. Additionally, the thickness of the wall 44 between the threads 30,34 is minimized by forming the threads 30,34 such that the major diameter of the internal threads 34 formed at their troughs 36 is greater than the minor diameter of the external threads 30 formed at their troughs 38. As a result, the adapter ring 20 can be used to transition between minimal diameter differentials in the connection.

In use, the adapter ring 20 can be used to transition between, for example, a ½-inch male member 12 and a 15/16-inch female nut 16. In such a case, the adapter ring 20 will have inner diameter of ½-inch and an outer diameter of 15/16 inch. The adapter 20 may be threadably attached to the male threaded member 12. Thereafter, the female nut 16 is threadably attached to the adapter ring 20 creating a secure connection between the components while not adding substantial length to the connection.

The foregoing detailed description has been given for clearness of understanding only and no unnecessary limitations should be understood therefrom as some modifications will be obvious to those skilled in the art without departing from the scope and spirit of the appended claims.

1. A connecting ring adapted to connect a female connector to a male connector, said ring comprising:
a tubular body having an axial passageway, said body including an inner surface having a predetermined first diameter and an outer surface having a predetermined second diameter;
an internal thread formed on said inner surface an external thread formed on said outer surface wherein said internal thread and external thread are coaxially formed on said tubular body.

2. The ring as defined in claim 1 wherein said internal thread and said external thread are concentrically formed on said tubular body.

3. The ring as defined in claim 2 wherein said internal thread and said external thread include troughs and crests defining said threads.

4. The ring as defined in claim 3 wherein said troughs of said internal thread are radially aligned with said crests of said external thread and said crests of said internal thread are radially aligned with said troughs of said external thread.

5. The ring as defined in claim 4 wherein said troughs of said internal thread have a diameter greater than said troughs of said external threads.

6. The ring as defined in claim 2 wherein said tubular body includes a radial flange.

7. A connecting ring adapted to connect a female connector to a male connector, said ring comprising:
a tubular body having an axial passageway, said body including an inner surface having a predetermined first diameter and an outer surface having a predetermined second diameter;
an internal thread formed on said inner surface adapted to threadably engage the male connector and an external thread formed on said outer surface adapted to threadably engage the female connector wherein said internal thread and said external thread are concentrically formed on said tubular body.

8. The ring as defined in claim 7 wherein said internal thread and said external thread include troughs and crests defining said threads.

9. The ring as defined in claim 8 wherein said troughs of said internal thread are radially aligned with said crests of said external thread and said crests of said internal thread are radially aligned with said troughs of said external thread.

10. The ring as defined in claim 9 wherein said troughs of said internal thread have a major diameter greater than a minor diameter of said troughs of said external thread.

11. A connecting ring adapted to connect a female connector to a male connector, said ring comprising:
a tubular body having an axial passageway, said body including an inner surface having a predetermined first diameter and an outer surface having a predetermined second diameter;
an internal thread formed on said nine surface adapted to threadably engage the male connector and an external thread formed on said outer surface adapted to threadably engage the female connector wherein said internal thread and said external thread are harmonically aligned and concentrically formed on said tubular body.

12. The ring as defined in claim 11 wherein said internal thread and said external threads include troughs and crests defining said threads.

13. The ring as defined in claim 12 wherein said troughs of said internal thread are radially aligned with said crests of said external thread and said crests of said internal thread are radially aligned with said troughs of said external thread.

14. The ring as defined in claim 13 wherein said troughs of said internal thread have a major diameter greater than a minor diameter of said troughs of said external thread.
